(19) United States
(12) Patent Application Publication
(10) Pub. No.: US 2018/0096291 A1
(43) Pub. Date: Apr. 5, 2018

(54) METHOD, SYSTEM, AND APPARATUS FOR PROMOTIONAL DISPLAY AND INFORMATION GATHERING

(71) Applicant: Avery Dennison Retail Information Services, LLC, Mentor, OH (US)

(72) Inventor: Mark W. ROTH, North Miami, FL (US)

(21) Appl. No.: 15/725,921

(22) Filed: Oct. 5, 2017

Related U.S. Application Data
(60) Provisional application No. 62/404,398, filed on Oct. 5, 2016.

(51) Int. Cl. G06Q 10/08; G06K 7/10; G06K 19/07

(52) U.S. Cl. CPC G06Q 10/087; G06K 7/10207; G06K 19/0723; G06K 7/10366

(57) ABSTRACT

A method and system for performing inventory in a retail environment. The method and system can include a plurality of child smart signs disposed proximate a plurality of products, the smart signs having an RFID reader and having at least one other short distance communication device associated therewith, and the products having an RFID tag disposed thereon; one or more parent smart signs disposed proximate the plurality of child smart signs, the plurality of parent smart signs, each of the one or more parent smart signs receiving RFID data from a predetermined group of the plurality of child smart signs; a Wi-Fi node communicatively coupled to the one or more parent smart signs; and a server communicatively coupled to the Wi-Fi node for performing inventory using product data obtained from the plurality of products.

### CROSS REFERENCE TO RELATED APPLICATION(S)

This application claims priority to and the benefit of U.S. provisional patent application No. 62/404,398 filed on Oct. 5, 2016, which is incorporated herein by reference in its entirety.

### BACKGROUND

Conducting inventory is a well-known process for accounting for products a store has on hand or otherwise counting and sorting items on hand. Traditionally, in many retail environments, products or containers were marked or printed with barcodes and associated stock keeping unit (SKU) that could be read by a statically located barcode scanning device, for example at a check-out area, or a handheld barcode scanning device. Typically a barcode scanning device would require an operator to touch or manipulate every item to be scanned, locate the barcode SKU label, and optically scan it into the system with the barcode scanning device. Thus, in order to conduct an inventory of a store's physical products, the method is high time and labor intensive and usually requires a significant number of people to physically perform the job. As a result, conducting inventory is traditionally very high cost and therefore undesirable or challenging to perform at regular intervals. Third party vendors thus arose to perform inventory tasks, although the cost remained impactful on the stores. As a result, studies have shown that typical retail stores have an actual inventory that is only 65% accurate. Given the modern trend towards omni-channel sales models, such a discrepancy in inventory would be untenable due to the need to provide customers from multiple channels with immediate product availability information.

More recent solutions to make conducting inventory more efficient utilize radio frequency identification (RFID) tags. Because RFID tags can passively or actively transmit a radio signal that can be read by an RFID reader, an operator of the RFID reader can save significant time over a barcode reader operator because each item does not need to be physically touched or manipulated in order to obtain desired product information. Instead, the operator can walk at a regular pace and wave the RFID reader in order to capture every tag within the range of the RFID reader. Thus, the time for conducting an inventory can be significantly decreased. However, the utilization of an RFID reader to conduct inventory still requires the operator to be physically present among the products to be scanned and still must account for human error in failing achieve an appropriate distance to read all RFID tags or failing to scan certain areas in their entirety.

Additionally, retail stores and environments utilize a variety of tools and methods to attract the attention shoppers and promote products. A common method is placing a two- or four-sided sign (often 8″×11″) on or near a product and advertising it as being “on sale”, new, associated with some form or promotion, priced at a particular price point, or the like. The signs are typically inexpensive paper media that can be made, reused, changed, and disposed of at a low cost to the store itself. The signs can be coupled with stands, such as inexpensive clear plastic stands, to provide further flexibility in locating the sign, coupling the sign to shelving, or otherwise positioning the sign. The signs can further include store branding, printed information, bright colors and graphics, and the like to draw the attention of viewers. Additionally, the sign and an associated stand can be moved and situated to meet the needs of a sale or promotion or they can be together with other signs and stands to draw more attention to a product or area of a store. As a result, in a typical retail environment, there are often numerous display stands positioned through the environment, typically in all areas where shoppers and products are located. These stands, along with their associated signs, are utilized only to provide placement and position of their respective signs without other capabilities.

Additionally, while overhead readers can be employed to conduct mass readings of RFID tags and their related data, such solutions are not optimal. Overhead readers are typically expensive and complex to implement. They typically require overlapping fields of coverage to be effective, resulting in the need for the static installation of many readers. Thus, installation causes a disruption of the services of a retail location to install the readers and testing to achieve the desired coverage at great time and expense. Additionally, if any change in the layout of the location of the overhead reader deployment is desired, then the readers must be repositioned or reinstalled.

### SUMMARY

According to at least one exemplary embodiment, system for performing inventory in a retail environment may be provided. The system can include a plurality of child smart signs disposed proximate a plurality of products, the smart signs having an RFID reader and having at least one other short distance communication device associated therewith, and the products having an RFID tag disposed thereon; one or more parent smart signs disposed proximate the plurality of child smart signs, the plurality of parent smart signs, each of the one or more parent smart signs receiving RFID data from a predetermined group of the plurality of child smart signs; a Wi-Fi node communicatively coupled to the one or more parent smart signs; and a server communicatively coupled to the Wi-Fi node for performing inventory using product data obtained from the plurality of products.

In another exemplary embodiment, a method of performing inventory in a retail environment may be shown and described. The method can include placing a plurality products, each having an RFID tag containing information about a product, in a retail location; providing a first RFID reader disposed in a first sign related to the plurality of the products proximate the first plurality of products; reading, at a predetermined time, product data from the RFID tags on the plurality of products with the first RFID reader; transmitting, via Bluetooth transmission, the product data from the plurality of products from the first RFID reader in the first sign to at least a second RFID reader disposed in at least a second sign proximate at least a second plurality of products, reading, at a predetermined time, product data from the RFID tags on the at least second plurality of products by the at least second RFID reader; transmitting data including the data from the plurality of products proximate the first RFID reader in the first sign and the data from the least second plurality of products proximate the at least second RFID reader in the at least second sign to a parent communication device; combining the data regarding the at least first plurality of products and the at least second plurality of products in the parent communication device, the parent communication device including Bluetooth and Wi-Fi data transmission capabilities; transmitting the combined product data via Wi-Fi to a server; and performing, with a processor on the server, an inventory of the first plurality of products and the at least second plurality of products.

### BRIEF DESCRIPTION OF THE FIGURES

FIG. 1 is an exemplary embodiment of a data transmission device in a media stand.

FIG. 2 is an exemplary exploded view of a data transmission device in a media stand.

FIG. 3 is an exemplary view of a data collection and transmission network.

FIG. 4 is an exemplary view of a range of products associated with a data collection and transmission device.

FIG. 5 is an exemplary view of a sensor network.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, sequences of actions described herein can be embodied entirely within any form of computer-readable storage medium such that execution of the sequence of actions enables the at least one processor to perform the functionality described herein. Furthermore, sequences of actions described herein can be embodied in a combination of hardware and software. Thus, various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

Generally referring to the figures, a new apparatus, method, and system for providing data collection and communication may be shown and described. In some exemplary embodiments, radio frequency identification (RFID) devices may be embedded in signs or stands for signs in a retail environment, shopping location, storage location, or any combination thereof. The embedded RFID devices may communicate with RFID readers disposed throughout the location. Additionally, the RFID devices and RFID readers may have a hierarchy of functions, functionality, or capabilities. Additionally, the RFID devices and RFID readers may be communicatively coupled to database having associated storage and software capabilities.

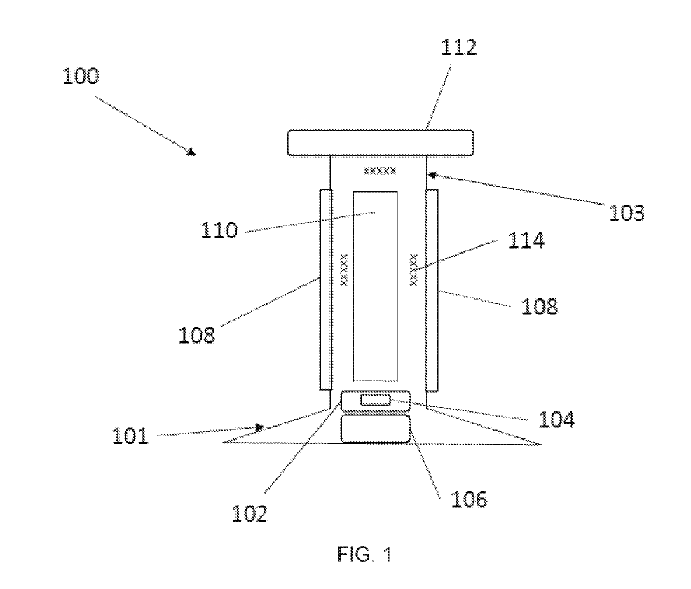

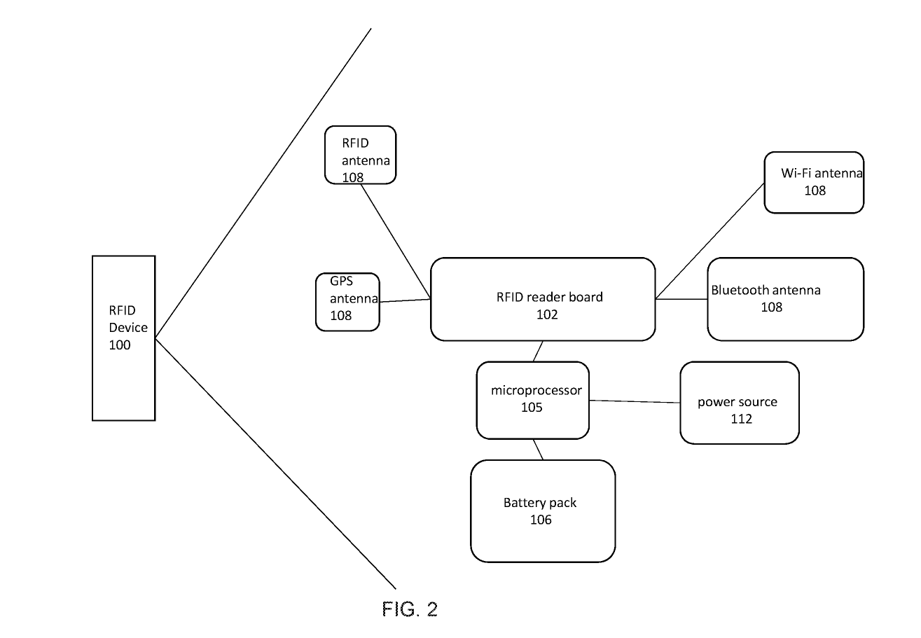

Turning now to exemplary FIG. 1 and the exploded view of exemplary FIG. 2, a communication device may be embedded in a stand, such as a sign stand. The transmission device 100 may be formed to have its components embedded in a stand formed with a base 101 and a vertical portion 103. It may be appreciated that in other exemplary embodiments the stand is formed with different dimensions and any number of base and vertical elements. Further, the stand can be any size or shape, as desired. In one exemplary embodiment, the stand of transmission device 100 may be approximately eight inches wide by about 11 inches wide, or any other dimensions depending on the media to be displayed. The stand may be formed out of a clear plastic material, or any other material known for providing media displays.

In the exemplary embodiment of FIG. 1, base 101 may provide support and allow the stand to be free-standing. Vertical element 103 may also for the display of printed, or otherwise visual, media there on. For example, printed media 114 may be disposed on an interior pocket or cavity of vertical element 103. In such embodiments printed media 114 may be inserted through a slot or other type of opening as is generally known. In other exemplary embodiments, printed media 114 may be coupled or adhered, for example removably coupled or adhered, to an exterior portion of vertical element 103 and/or over antennas 108 in such a manner as not to cause any disruption or interference with antennas 108. Further, it may be appreciated that base 101 and vertical element may have any other printing, engraving, or branding disposed thereon, as is known. Printed media may, for example, provide information about a product, pricing or sale information on a product, or any type of graphics that can be used to get the attention of a shopper or viewer. As such, transmission device 100 may be generally deployed or located proximate products or items related to printed media 114 displayed on the device 100.

Still referring to exemplary FIG. 1, transmission device 100 may have any number of antennas 108 disposed thereon, for example RFID antennas. In the exemplary embodiment, both a front and a rear of vertical element 103 have RFID antennas 108 disposed thereon. The RFID antennas may be formed integrally in vertical element 103, for example encased in plastic forming vertical element 103, may be printed or otherwise disposed on vertical element 103, or otherwise coupled to vertical element 103. Additionally, depending on desired orientation and deployment of RFID device 100, it may be appreciated that RFID antennas 108 may be disposed in other locations of device 100, as desired.

As discussed above, antennas 108 may be external antennas and it may be appreciated that the antennas 108 may be deployed, modified, or customized, for example, based on customer or location desires or requirements. It may be appreciated that there may be any number of antennas 108 which may be associated with any combination of RFID, Wi-Fi, GPS (global positioning system), Bluetooth, and the like, transmissions. The antennas may be laser cut foil designs that can be formed and deployed in a very cost effective manner and in such a fashion that they are coupled or bonded to stand 101 or vertical element 103 of transmission device 100 in a desired manner. Additionally, antennas 108 on transmission device 100 may be tailored for specific purposes or range. For example, antennas 108 may be broad field or (very) narrow field. Broad field antennas may be utilized for gathering inventory data about all products within a field range. Narrow field may be utilized where information about products on a specific rack or shelf are desired, for example during a specific sale or promotion related to a specific product or products.

The stand 101 in exemplary FIG. 1 may further house a variety of RFID components and elements. The orientation of such elements in FIG. 1 is merely exemplary and it should be appreciated that other orientations that provide appropriate functionality may also be utilized. Thus, an RFID reader board 102 may be disposed in stand 101. RFID reader board 102 may include a microprocessor 105, Bluetooth transmitter, global positioning system (GPS) transmitter, cellular transmitter, Wi-Fi transmitter and provide the functionality associated with these data communicating elements. Further, RFID reader board 102 may include power management capabilities. RFID reader board 102 may further include multiple antenna ports and general purpose input/output (GPIO) ports. The GPIO ports on RFID reader board 102 may be utilized, for example, to control external devices 104. External devices 104 may be coupled to RFID reader board 102 and may include, but are not limited to, one or more lights, other visual electronic indicia, a speaker, and/or a sound device. Additionally, RFID reader board 102 may utilize or run any of a variety of intelligent software models or programs. Such software models and programs may be utilized for management of data gathering, device management, data reporting, data communications, and smart power management, as desired.

As noted above, transmission device 100 may have power management capabilities as part of its RFID reader board 102. The RFID reader board 102, and transmission device 100, may be powered using a battery pack, wired power connection, solar power, or the like, as desired. In an exemplary embodiment shown in FIG. 1, solar panel 112 may collect and convert solar or light energy into stored electrical energy in battery pack 106 as a renewable or supplemental power source, for example charging battery pack 106. Alternatively, it may be appreciated that transmission device 100 may be powered or have its power supplemented by other passive energy capture techniques, including chemical and thermal methods. Additionally, battery pack 106 may be a common or known battery pack, thus allowing for efficient and inexpensive deployment and maintenance. For example, battery pack 106 may be a known version of a lithium ion battery commonly utilized in handheld tools.

In the exemplary embodiments of FIGS. 1-2, it may be appreciated that transmission device 100 may be used or utilized in any of a variety of fashions. For example, device 100, in addition to displaying media such as a paper sign advertising or promoting a physical product, could act as an IP device, could be used in a sensor network, or could be used as a transmitter or exciter. Device 100 could be positioned in any desired location, for example on a shelf, on top of a platform, hanging from an overhead member, mounted on a rack, or otherwise positioned. Additionally, if device 100 is used as an RFID device, it may be used in a standalone fashion or it may be used in conjunction with one or more overhead readers in a RF networked environment. Additionally, it may be appreciated that device 100 may operate in any of a variety of modes. For example, device 100 may be powered at all times and capable of sending and/or receive RF data (or any other data described herein) at all times. Alternatively, device 100 may function on a timed schedule, activating at predetermined or desired times to provide transmission of data within a sphere of influence. In such situations, device 100 may be maintained in an idle or sleep state, consuming very low power while maintaining a timer or schedule, and then briefly activate as desired.

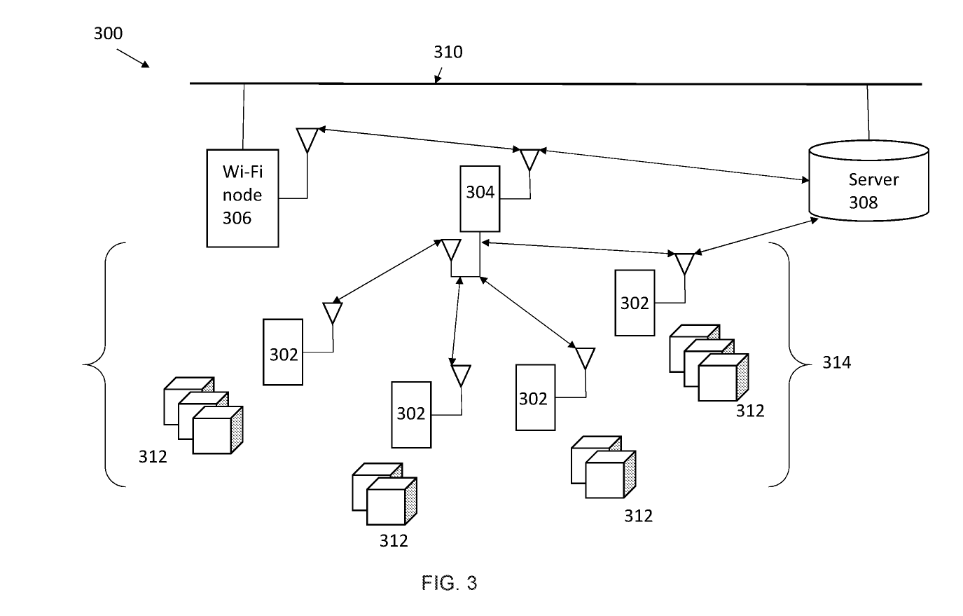

Referring now to exemplary FIG. 3, a network 300 of transmission devices may be provided. In this exemplary embodiment, a network of data transmission and storage device may work cooperatively to provide product and inventory information. Here any number of smart signs 302 may be deployed or otherwise arranged in a desired environment, such as a retail location. Smart signs 302 may generally be formed and correspond with the transmission device 100 described with respect to exemplary FIGS. 1-2. As is known, traditional signs are located in numerous locations through retail locations in order to provide product information, advertise a sale, promote a product or event, and otherwise attract the attention of consumers. The use smart signs 302 in such locations can provide a network 300 to collect and analyze data about products located throughout the retail location.

Still referring to exemplary FIG. 3, smart signs 302 in network 300 can provide an efficient manner of conducting on demand inventories of products 312 that are appropriately tagged or designated. For example, the products 312 may be tagged with RFID tags, as is known in the art. It is further envisioned that products 312 may be arranged or located in any standard fashion, for example on shelves, associated with a product display, or other typical product display arrangements.

Each smart sign 302 may further be configured to communicate directly with other communication devices. In one exemplary embodiment, each smart sign 302 may be configured to transmit and receive data or otherwise communicate with the server 308. However, in another exemplary embodiment, each smart sign 302 may be configured as part of a sensor network 314. In sensor network 314, smart signs 302 may have a parent-child priority where groups of individual units communicate with a parent. In this exemplary embodiment, smart sign 304 may be designated as the parent. Thus, in sensor network 314, each smart sign 302 functions as a child of parent smart sign 304. Parent smart sign 304 then acts as a conduit for communication to server 308. In some exemplary embodiments, parent smart sign 304 may transmit data in a wired or wireless fashion, for example over Wi-Fi, to Wi-Fi node 306. The data may then be transmitted over wired or wireless connection 310 to server 308. Such a network 300 may allow for an on demand, rapid inventory to take place without the need for human-operated barcode or RFID scanners, or more expensive overhead RFID readers. Additionally, network 300 can allow for a mass collection of data at desired times without crashing or overburdening server 308 which received data that it is tasked with processing and storing. Thus, if there are numerous sensor networks 314 that include various other child smart signs and parent smart signs, these sensor networks 314 can be activated at desired or predetermined intervals to scan products 312 and effectively conduct an inventory. Smaller amounts of data related to particular sensor networks 314 may then be transmitted piecemeal to server 308, allowing for the system to operate without any component being flooded or overburdened.

Sensor network 314 of parent smart sign 304 and child smart signs 302 may also alleviate information technology system and infrastructure problems by limiting the number of IP connected devices on network 300. In an exemplary embodiment, hundreds or even thousands of smart signs 302 could be deployed in a retail location. However, smart signs 302 can communicate with each other via non-IP methods, such as local communication via Bluetooth. Then, parent smart signs 304, which may be a fractional number of the child smart signs 302, may communicate desired data to server 308, as described above. Thus, while a seemingly large number of data collection and transmission devices are deployed in a location, relatively few will be utilizing the IT infrastructure of that location. Thus, concerns about bandwidth and system failures can be mitigated.

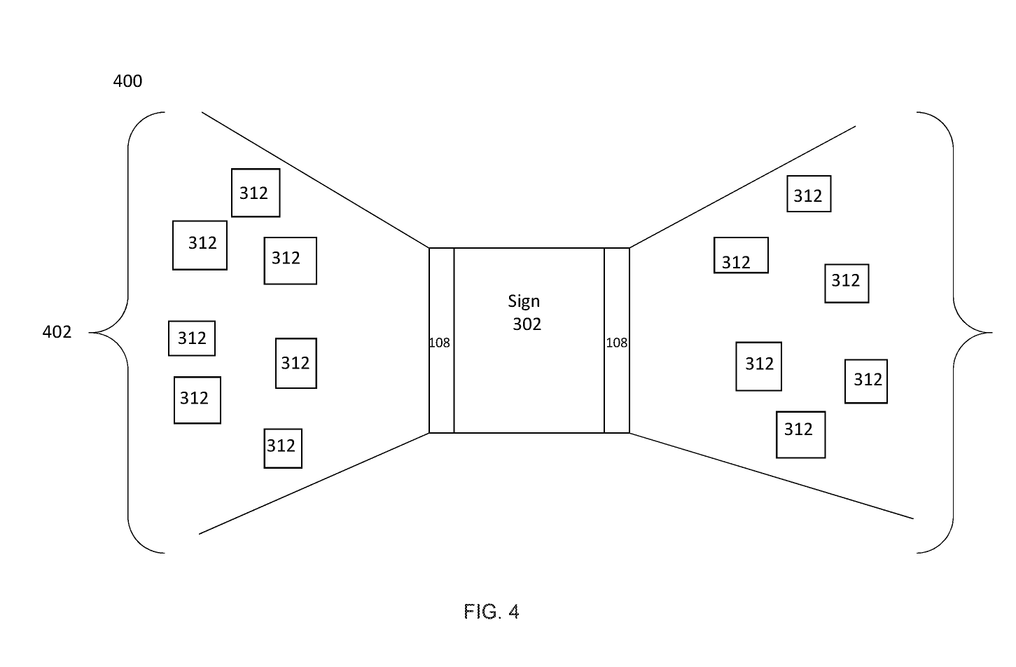

In such an exemplary embodiment, each child smart sign 302 can have a specific “view” or range by which it can collect RFID tag information. This can be seen in exemplary FIG. 4. In exemplary FIG. 4, a child smart sign's view or range is shown as range 402. Information about products 312 in range 402 is collected by child smart sign 302. It is envisioned in this exemplary embodiment that products 312 are equipped with a passive RFID tag that is activated by a signal sent from antennas 108 of child smart sign 302 and that child smart sign 302 receives an RFID signal in return from the RFID tags of products 312, as is known in the art. This data is then sent to parent smart sign 304 for consolidation and, ultimately, transmission to server 308.

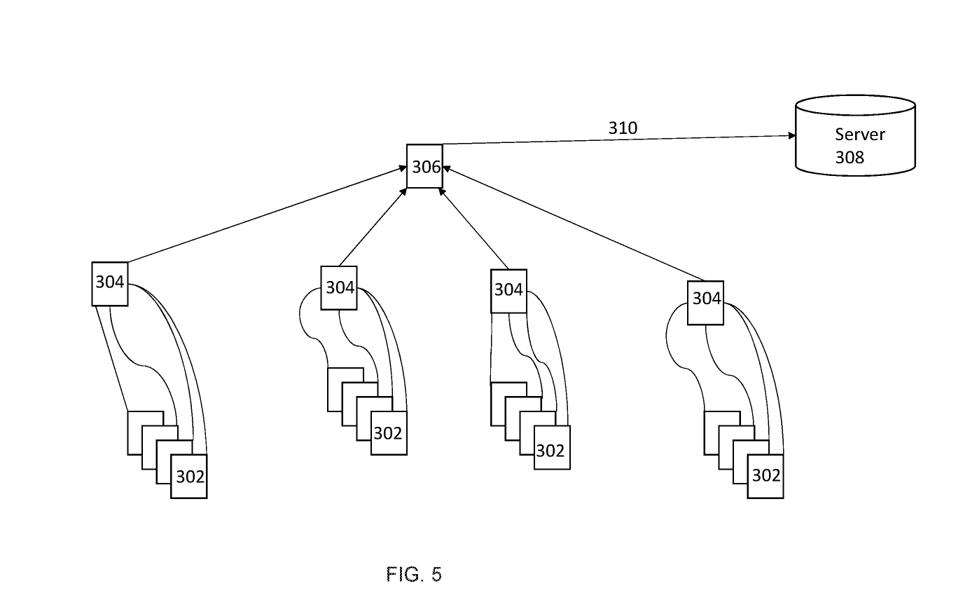

In a further exemplary embodiment, and generally referring to FIGS. 3 and 4, each child smart sign 302 and parent smart sign 304 may be part of a sensor network 314, as described above. Further, each smart sign 302/304 may communicate directly with one another, for example using short range communication and data transmission protocols, such as Bluetooth. Referring now to exemplary FIG. 5, each child smart sign 302, when active, can effectively transmit product inventory data to one another and then to parent smart sign 304. In exemplary FIG. 5, multiple groups of child smart signs 302 can be seen transmitting data to and from parent smart signs 304. Parent smart signs 304 can then receive or gather the data collected by each group of child smart signs 302, bundle and combine the data into a consolidated report to be transmitted to the server 308, for example through Wi-Fi node 306 and further over connection 310. This communication does not cause bandwidth issues with respect to the data sent to the server 308 or affect its data processing capabilities, as the data can be sent in clusters, as described above. Connection 310 is not burdened with individual communications between child smart signs 302 or between child smart signs 302 and parent smart signs 304.

Thus, as described herein with respect to the exemplary embodiments, the utilization of a parent smart sign 304 and child smart sign 302 sensor network 314 may provide a variety of benefits. As discussed above, the sensor network may limit data flow that may affect performance of an internal IT infrastructure. Additionally, as individual child smart signs 302 are not directly connected with a primary IT infrastructure and cannot communicate directly with server 308, child smart 302 may be secure in large, public deployments as attempts to manipulate or hack these devices will not impact server 308 or other significant IT infrastructure.

Additionally, as described herein, sensor network 314 can provide on-demand, extremely accurate inventory data. In still further exemplary embodiments, a location function may also be provided. For example, child smart sign 302 could have GPS capabilities (similar to those described with respect to exemplary FIGS. 1-2). Thus, child smart signs 302 could provide location information of each tagged product 312. Additionally, the GPS capabilities may also allow signs in sensor network 314 to act as beacons to draw attention to a customer or other personnel. For example, using the audio and/or visual capabilities of a child smart sign 302, a light or sound could be provided to alert a customer of, for example, a sale, or provide an alert to nearby personnel that the sign is low on power or otherwise malfunctioning. As there may be numerous child smart signs 302 in a close area, the GPS information could provide information as to a location of the sign and the audio or visual cue could provide a viewer with an indication of the exact child smart sign 302.

Thus it is envisioned that exemplary embodiments described herein may provide a highly dynamic, low cost system for conducting inventory and otherwise reading, scanning, and monitoring products or items in a desired area. The smart signs can be deployed in any location and relocated quickly and easily without any disruption to retail or other location activities or services. Further, the system can be configured as part of an internet of things (IoT) insofar as it can act to provide directed selling with a smart device possessed by a customer. Then, for example, a retailer could up sell such a customer on additional items that may be related to one they are viewing, selecting, or purchasing. Additionally, the system can be utilized as a search and locate tool that assist customers as to the vicinity of items or products they are looking for. Such a tool could further be implemented as part of customer loyalty or rewards program or a benefit of membership.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art; for example, features associated with certain configurations of the invention may instead be associated with any other configurations of the invention, as desired.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for performing inventory in a retail environment, comprising:
a plurality of child smart signs disposed proximate a plurality of products, the smart signs comprising an RFID reader and having at least one other short distance communication device associated therewith, and the products each having an RFID tag disposed thereon;
one or more parent smart signs disposed proximate the plurality of child smart signs, each of the one or more parent smart signs receiving data from a predetermined group of the plurality of child smart signs via the short distance communication devices on the plurality of child smart signs;
a Wi-Fi node communicatively coupled to the one or more parent smart signs; and
a server communicatively coupled to the Wi-Fi node for performing inventory using product data obtained from the plurality of products.

2. The system of claim 1, wherein the plurality of child smart signs receive product information from the products disposed proximate to the plurality of child smart signs via RF transmission and transmit the product information to a predetermined parent smart sign via Bluetooth transmission.

3. The system of claim 2, wherein each of the plurality of parent smart signs receives the product information from the predetermined group of child smart signs and transmits the data to the server for processing and determining an inventory of the plurality of products.

4. The system of claim 1, wherein each of a plurality of groups of the plurality of child smart signs communicates only with a predetermined parent smart sign in the plurality of parent smart signs.

5. The system of claim 1, wherein each child smart sign in the plurality of child smart signs further comprises a solar panel and a battery pack.

6. The system of claim 1, wherein each child smart sign in the plurality of child smart signs further comprises a display for printed media.

7. The system of claim 1, wherein each child smart sign in the plurality of child smart signs further comprises as least one of an electronic visual indicia and an audio indicia.

8. The system of claim 1, wherein the plurality of child smart signs are in a sleep state until activated at a predetermined time.

9. The system of claim 1, wherein the plurality of child smart signs do not communicate directly with the server or the Wi-Fi node.

10. The system of claim 1, wherein each child smart sign in the plurality of child smart signs further comprises GPS capabilities.

11. A method of conducting inventory in a retail location, comprising:
placing a plurality products, each having an RFID tag containing information about a product, in a retail location;
providing a first RFID reader disposed in a first sign related to the plurality of the products proximate the first plurality of products;
reading, at a predetermined time, product data from the RFID tags on the plurality of products with the first RFID reader;
transmitting, via Bluetooth transmission, the product data from the plurality of products from the first RFID reader in the first sign to at least a second RFID reader disposed in at least a second sign proximate at least a second plurality of products,
reading, at a predetermined time, product data from the RFID tags on the at least second plurality of products by the at least second RFID reader;
transmitting data comprising the data from the plurality of products proximate the first RFID reader in the first sign and the data from the least second plurality of products proximate the at least second RFID reader in the at least second sign to a parent communication device;
combining the data regarding the at least first plurality of products and the at least second plurality of products in the parent communication device, the parent communication device comprising Bluetooth and Wi-Fi data transmission capabilities;
transmitting the combined product data via Wi-Fi to a server; and
performing, with a processor on the server, an inventory of the first plurality of products and the at least second plurality of products.

12. The method of claim 11, further comprising:
keeping the first RFID reader and the at least second RFID reader in a sleep mode until a predetermined time.

13. The method of claim 11, further comprising:
combining GPS location data with the first product data obtained by a GPS transmitter on the first sign and GPS location data obtained by a GPS transmitter on the at least second sign with the at least second product data at the parent communication device; and
remotely activating at least one of a visual or audio indicia on the first sign and the at least second sign.

14. The method of claim 11, further comprising powering the first RFID reader and the at least second RFID reader with at least one of a solar panel and a battery pack.

15. The method of claim 11, further comprising transmitting product data about at least one of the plurality of products disposed proximate the first sign to a smart device.

16. The method of claim 15, further comprising activating at least one of a visual or audio indicia on the first sign.

17. The method of claim 11, further comprising displaying visual indicia related to the first plurality of products on the first sign and displaying visual indicia related to the at least second plurality of product on the at least second sign.
